(19) United States
(12) Patent Application Publication
(10) Pub. No.: US 2018/0202385 A1
(43) Pub. Date: Jul. 19, 2018

(54) CONTROL DEVICE FOR INTERNAL COMBUSTION ENGINE

(71) Applicant: TOYOTA JIDOSHA KABUSHIKI KAISHA, Toyota-shi (JP)

(72) Inventors: Koji MIWA, Shizuoka-ken (JP); Takahiro TSUKAGOCHI, Susono-shi (JP); Koichi KITAURA, Odawara-shi (JP); Kenji INOSHITA, Okazaki-shi (JP); Takeru YOSHIDA, Miyoshi-shi (JP); Isao CHINZEI, Susono-shi (JP)

(73) Assignee: TOYOTA JIDOSHA KABUSHIKI KAISHA, Toyota-shi (JP)

(21) Appl. No.: 15/870,912

(22) Filed: Jan. 13, 2018

(30) Foreign Application Priority Data
Jan. 17, 2017 (JP) 2017-005783

(51) Int. Cl. F02D 41/40; F02D 41/00; F02D 41/06; B60W 10/06; B60W 10/08; B60W 20/15; B60W 30/188

(52) U.S. Cl. CPC F02D 41/401; F02D 41/0002; F02D 41/065; F02D 41/3029; B60W 10/08; B60W 20/15; B60W 30/188; B60W 10/06

(57) ABSTRACT

A direct injection injector injects all of fuel having an idle required fuel amount required for an idle operation and makes a port injection injector inject no fuel from a second time to a third time so that an internal combustion engine executes idle operation from second time to third time. A fuel cut operation in which the fuel is not injected from both the direct injection injector and the port injection injector is executed from third time so that operation of the internal combustion engine is stopped at or after third time. At least one of the direct injection injector and the port injection injector inject the fuel so that operation of the internal combustion engine is restarted when a predetermined engine restart condition is satisfied under a state where operation of the internal combustion engine is stopped at or after third time.

### BACKGROUND OF THE INVENTION

### 1. Field of the Invention

The present invention relates to a control device for an internal combustion engine that restarts operation of the internal combustion engine when a restart condition is satisfied after the operation is stopped.

### 2. Description of the Related Art

A hybrid vehicle is equipped with an internal combustion engine and an electric motor as a driving source of driving force to make a vehicle travel. That is, the hybrid vehicle travels while transmitting the driving force generated by at least one of the internal combustion engine and the electric motor to driving wheels of the vehicle.

In the hybrid vehicle, a driver request torque is determined based on an operation amount of an accelerator pedal by a driver and vehicle speed. The driver request torque is a torque that is required for a gear (for example, a ring gear) of a power dividing mechanism coupled to a drive shaft so as to be able to transmit torque. Further, a driver request output is determined based on a value corresponding to the product of the driver request torque and the rotation speed of the drive shaft (i.e., the vehicle speed). Further, an engine required output is calculated based on this driver request output, and the internal combustion engine generates the engine required output. At this time, the engine output torque and an engine speed are determined so that the internal combustion engine can be operated most efficiently. That is, in the hybrid vehicle, the internal combustion engine generates an output equal to the engine required output while the operating state of the internal combustion engine (the engine output torque and the engine speed) is adjusted so that the internal combustion engine can be operated most efficiently. Then, when the torque, which is based on the engine output torque and acts on the gear of the power dividing mechanism, is smaller than the driver request torque, the electric motor is controlled so as to output a torque corresponding to a difference between the torque and the driver request torque.

By the way, a dual injection type internal combustion engine, which includes a direct injection injector capable of injecting fuel (gasoline) into a combustion chamber formed by a cylinder and a piston reciprocating in the cylinder and a port injection injector capable of injecting the fuel into an intake port connected to the cylinder, is well-known (see, for example, Japanese Patent Application Laid-open No. 2006-274949). In this internal combustion engine, a ratio between the amount of fuel injected from the direct injection injector and the amount of fuel injected from the port injection injector is adjusted according to its operating state. In recent years, a hybrid vehicle equipped with the dual injection type internal combustion engine is also proposed (see, for example, Japanese Patent No. 5862296 and Japanese Patent No. 5682581).

Also in the hybrid vehicle equipped with the dual injection type internal combustion engine, an intermittent operation of the internal combustion engine is executed. That is, when the output required for the internal combustion engine is equal to or less than an engine stop threshold (threshold output), the operation of the internal combustion engine is stopped and only the electric motor generates the driving force of the vehicle. The operation of the internal combustion engine is restarted when the output required for the internal combustion engine becomes larger than an engine startup threshold under a state where the operation of the internal combustion engine is stopped.

### SUMMARY OF THE INVENTION

Typically, when the internal combustion engine restarts its operation, the amount of hydrocarbon (HC) contained in the exhaust gases becomes larger than when the internal combustion engine continues a normal operation. On the other hand, in hybrid vehicles, the operation of the internal combustion engine is frequently restarted due to the intermittent operation. Furthermore, even in a vehicle, which is not a hybrid vehicle and has an internal combustion engine carrying out so-called start and stop control (automatic stop/restart control), the operation of the internal combustion engine is frequently restarted. Thus, in order to reduce the amount of HC emitted into the atmosphere from the internal combustion engine (HC emission amount), the necessity of lowering HC concentration in the exhaust gas when the operation of the internal combustion engine is restarted is increasing. However, there is a problem that the HC concentration in the exhaust gas when the dual injection type internal combustion engine restarts its operation is not sufficiently reduced.

The present invention has been made to cope with the above problems, and has an object to provide a control device for internal combustion engine that can reduce HC concentration in exhaust gas when the operation of the dual injection type internal combustion engine is restarted, and thus can reduce emission amount of HC.

A control device for an internal combustion engine of the present invention (hereinafter, it may be referred as to “present invention device) is applied to the internal combustion engine (10) (dual injection type internal combustion engine) which comprises a direct injection injector (39C) and a port injection injector (39P).

The control device comprises a control unit (161) for driving (controlling) the direct injection injector and the port injection injector so that a state in which the fuel having an amount required for the internal combustion engine is injected from both the direct injection injector and the port injection injector and a state in which the fuel having an amount required for the internal combustion engine is injected from either the direct injection injector or the port injection injector selectively occurs depending on at least load of the internal combustion engine.

It is known that HC concentration in an exhaust gas when the operation of the internal combustion engine is restarted becomes higher as “the total amount of fuel adhering to the inner surface of the cylinder and the inner surface of the intake port (hereinafter, it may be simply referred to as “fuel adhesion amount”)” when the operation of the internal combustion engine is stopped becomes larger. Therefore, if the fuel adhesion amount when the operation of the internal combustion engine is stopped is reduced, the HC concentration in the exhaust gas when the internal combustion engine restarts its operation is lowered.

Thus, present invention device controls the direct injection injector inject and the port injection injector so that the internal combustion engine executes the idle operation from a second time (t2) to a third time (t3), and thereafter the internal combustion engine is stopped. The second time comes at or after a first time (t1) at which a predetermined engine stop request condition is determined to be satisfied. The third time comes when a predetermined period of time (Tidle) elapses from the second time (t2).

In this way, the present invention device executes the idle operation before stopping the internal combustion engine. Since the amount of fuel injected during the idle operation is relatively small compared to during the load operation, the fuel adhesion amount during the idle operation is lower than that during the load operation in which the load of the internal combustion engine is larger than that of when the idle operation is executed. Furthermore, fuel having large amount, which was adhered to the inner surface of the intake port during the load operation before the engine stop request condition is satisfied, is inhaled into the combustion chamber and burned during the idle operation. Therefore, the present invention device can reduce the fuel adhesion amount when the operation of the internal combustion engine is stopped compared with a device that stops operation of an internal combustion engine immediately after the engine stop request condition is satisfied. As a result, the present invention device can lower HC concentration when restating the operation of the internal combustion engine.

By the way, when the dual injection type internal combustion engine executes the idle operation, fuel is typically injected not only from the direct injection injector but also from the port injection injector in order to secure combustion stability and suppress noise caused by the operating sound of the direct injection injector.

However, it has been found that when the fuel is injected from both the direct injection injector and the port injection injector in the idle operation, which is executed after the engine stop request condition is satisfied and continues until the operation of the engine is stopped, the HC concentration in the exhaust gas when the internal combustion engine is subsequently restated cannot be lowered sufficiently.

Thus, the inventors conducted an experiment. In this experiment, the ratio between the amount of fuel injected from the direct injection injector and the amount of fuel injected from the port injection injector is changed in the idle operation to learn how the HC concentration changes. According to this experiment, as described in detail later, it has been found that when all of the fuel having amount required for the idle operation (idle required fuel amount) is injected from the direct injection injector in the idle operation, the HC concentration becomes the smallest. In other words, the inventors has discovered that if the fuel is injected only from the direct injection injector during the idle operation, the fuel adhesion amount when the internal combustion engine is stopped becomes the smallest.

Based on the discovery, the control unit (161) of the present invention device makes the direct injection injector inject all of the fuel having an idle required fuel amount required for an idle operation from the second time (t2) to the third time (t3) so that the internal combustion engine executes the idle operation from the second time, which comes at or after the first time, to the third time (steps 509, 512, and 508). Accordingly, the control unit makes the port injection injector inject no fuel from the second time to the third time.

Further, the control unit executes a fuel cut operation in which the fuel is not injected from both the direct injection injector and the port injection injector from the third time so that operation of the internal combustion engine is stopped at or after the third time (steps 513 and 514).

The control unit makes at least one of the direct injection injector and the port injection injector inject the fuel (steps 518, and 505 through 508) so that the operation of the internal combustion engine is restarted when a predetermined engine restart condition is satisfied (step 517: Yes) under a state where the operation of the internal combustion engine is stopped at or after the third time (step 502: No).

Therefore, since the present invention device can reduce the fuel adhesion amount when the operation of the internal combustion engine is stopped, it can lower the HC concentration in the exhaust gas generated when the operation of the internal combustion engine is restarted, and thus can reduce the HC emission amount.

In one aspect of the present invention,

the control unit is configured to:

make the direct injection injector inject the fuel having the idle required fuel amount from the first time to the third time (steps 512, 513, and 508) when temperature of the internal combustion engine is equal to or less than a predetermined temperature threshold (step 511: No), and

make the port injection injector inject some or all of the fuel having the idle required fuel amount and make the direct injection injector inject remaining part of the fuel having the idle required fuel amount from the first time to the third time (steps 515, 516, and 508) when the temperature of the internal combustion engine is higher than the temperature threshold (step 511: Yes).

When temperature of the internal combustion engine is less than or equal to the temperature threshold (that is, when the internal combustion engine is in a low temperature operation state (an operation under low temperature state, a warming-up operation state), the fuel injected into the intake port and/or into the combustion chamber is easier to adhere to the inner wall surface of the intake port and/or the inner wall surface of the combustion chamber and is harder to be mixed with air as compared with the case where the temperature of the internal combustion engine is higher than the temperature threshold (i.e., when the internal combustion engine is in a normal temperature operation state (an operation state after low temperature operation, an operation state after warming-up operation). Therefore, when the temperature of the internal combustion engine is less than or equal to the temperature threshold, the fuel adhesion amount tends to be larger than that of when the temperature of the internal combustion engine is higher than the temperature threshold. Therefore, when the present invention is executed in the above-described aspect, the effect of the present invention is increased.

Further, according to the above aspect, when the temperature of the internal combustion engine is higher than the temperature threshold, the amount of fuel injected from the direct injection injector during the idle operation can be reduced. As a result, the operating sound of the direct injection injector is reduced, so that possibility and frequency of the operating sound making an occupant of the vehicle uncomfortable can be reduced.

In one embodiment of the present invention device,

the internal combustion engine (10) is mounted on a hybrid vehicle (1) including an electric motor (122) as a driving source. The internal combustion engine serves as one of other driving sources of the hybrid vehicle.

The control unit (121) is configured to:

calculate an engine required output (Pe) required for the internal combustion engine based on a torque requested by a driver of the hybrid vehicle to make the hybrid vehicle travel, and

determine that the engine stop request condition is satisfied when a condition that the engine required output is equal to or less than a predetermined engine stop threshold is at least satisfied (step 503: No, step 510: Yes).

According to the conventional device, even if an operation of a dual injection type internal combustion engine, whose temperature is lower than or equal to the temperature threshold (i.e., in a low temperature operation state), is stopped after the idle operation, the fuel adhesion amount at that time cannot be made sufficiently small. Therefore, HC concentration in the exhaust gas generated when the operation of the internal combustion engine is restarted becomes high. Therefore, in the hybrid vehicle equipped with the dual injection type internal combustion engine controlled by the conventional device, even if the engine required output becomes equal to or less than the predetermined engine stop threshold, a driver (occupant) is not allowed to stop the operation of the internal combustion engine until the temperature of the internal combustion engine becomes higher than the temperature threshold.

However, when the present invention is executed in this aspect (that is, when it is applied to the hybrid vehicle), such a problem does not occur. That is, in this case, when the idle operation is executed under a state where the temperature of the dual injection type internal combustion engine is less than or equal to the temperature threshold, the fuel adhesion amount when the operation of the internal combustion engine is stopped does not become large, and thus the HC concentration in the exhaust gas generated when the operation of the internal combustion engine is restarted can be lowered. Thus, it is possible to stop the operation of the internal combustion engine and make the vehicle travel using only the electric motor before the temperature of the internal combustion engine becomes higher than the temperature threshold. As a result, it is possible to further improve the fuel efficiency of the hybrid vehicle while preventing the HC emission amount from becoming large.

In the above description, references used in the following descriptions regarding embodiments are added with parentheses to the elements of the present invention, in order to understand the invention. However, those references should not be used to limit the scope of the present invention.

Other objects, other features, and accompanying advantages of the present invention are easily understood from the description of embodiments of the present invention to be given referring to the following drawings.

### BRIEF DESCRIPTION OF THE DRAWINGS

FIG. 1 is a schematic plane view of a hybrid vehicle to which a control device for internal combustion engine according to an embodiment of the present invention is applied.

FIG. 2 is an overall view of the control device for the internal combustion engine and the internal combustion engine shown in FIG. 1.

FIG. 3 is a timing chart showing an operation of the control device for internal combustion engine shown in FIG. 1 using a plurality of state quantities of the internal combustion engine.

FIG. 4 is a graph showing a relationship between an injection share ratio in the internal combustion engine shown in FIG. 1 and HC concentration in exhaust gas.

FIG. 5 is a flowchart showing processing executed by the control device for the internal combustion engine shown in FIG. 1.

### DETAILED DESCRIPTION OF THE PREFERRED EMBODIMENTS

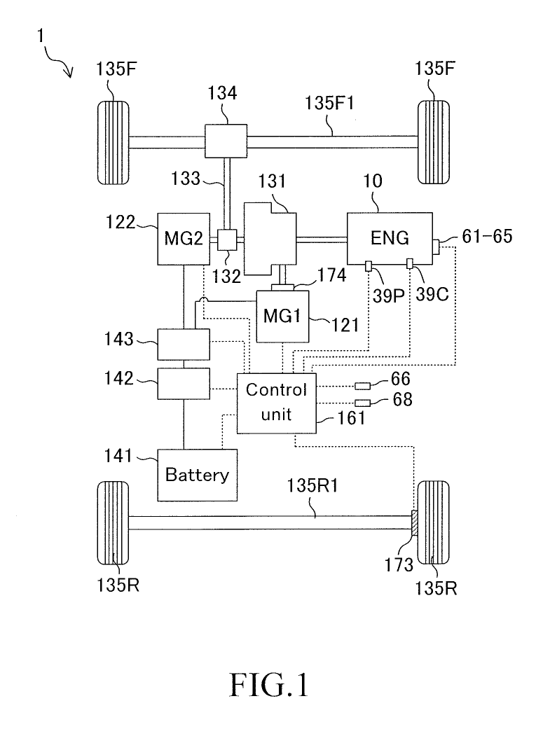

Hereinafter, a “control device for internal combustion engine” according to an embodiment of the present invention will be described with reference to the attached drawings. This control device is applied to an internal combustion engine 10, which is mounted on a vehicle 1 as one of drive sources, as shown in FIG. 1. In addition to this internal combustion engine 10, the vehicle 1 is provided with a first electric motor 121, a second electric motor 122, a power dividing mechanism 131, a pair of left and right front wheels 135F and a pair of left and right rear wheels 135R. That is, the vehicle 1 is a hybrid vehicle.

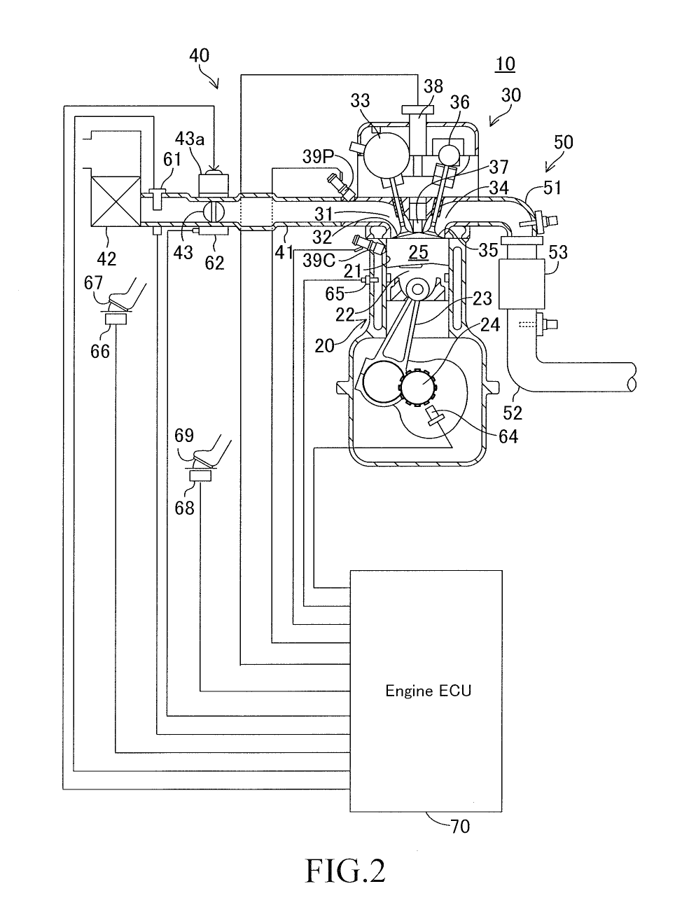

The internal combustion engine 10 shown in detail in FIG. 2 is a spark ignition type gasoline fuel engine equipped with a plurality of cylinders (for example, four cylinders). Although FIG. 2 shows only a cross section of one cylinder, the other cylinders have the same configurations.

The internal combustion engine 10 comprises a cylinder block portion 20 including a cylinder block, a cylinder block lower case, an oil pan and etc, a cylinder head portion 30 fixed to the top of the cylinder block portion 20, an intake system 40, and an exhaust system 50. The internal combustion engine 10 further comprises a port injection injector 39P and a direct injection injector 39C.

The cylinder block portion 20 comprises a cylinder 21, a piston 22, a connecting rod 23 and a crank shaft 24. The piston 22 reciprocates in the cylinder 21. The reciprocation of the piston 22 is transmitted to the crank shaft 24 via the connecting rod 23, which causes the crank shaft 24 to rotate. The space surrounded by the cylinder 21, the head of the piston 22 and the cylinder head portion 30 forms a combustion chamber 25.

The cylinder head portion 30 comprises two inlet ports 31 (only one inlet port 31 is shown in FIG. 2) communicating with the combustion chamber 25, two intake valves 32 (only one intake valve 32 is shown in FIG. 2) each of which opens and closes corresponding one of the inlet ports 31, and a VVT (variable valve timing mechanism) 33 for controlling the rotational phase of an intake camshaft (not shown) driving each of the intake valves 32. The cylinder head portion 30 further comprises two exhaust ports 34 (only one exhaust port 34 is shown in FIG. 2) communicating with the combustion chamber 25, two exhaust valves 35 (only one exhaust valve 35 is shown in FIG. 2) each of which opens and closes corresponding one of the exhaust ports 34, and an exhaust camshaft 36 driving each of the exhaust valves 35.

The cylinder head portion 30 further comprises an ignition plug 37 and an igniter 38 including an ignition coil generating a high voltage which is given to the ignition plug 37. The ignition plug 37 and the igniter 38 are components of an ignition device that generates a spark for ignition in the combustion chamber 25.

Fuel boosted to a predetermined low pressure is supplied from a fuel tank (not shown) to the port injection injector 39P by a low pressure fuel pump (not shown). The port injection injector 39P is arranged so as to inject the low pressure fuel into the inlet port 31 when it is opened by the intake valves 32.

Fuel boosted to a predetermined high pressure is supplied from a fuel tank (not shown) to the direct injection injector 39C by a high pressure fuel pump (not shown). The direct injection injector 39C is arranged so as to inject the fuel directly into the combustion chamber 25.

That is, the internal combustion engine 10 is a dual injection type internal combustion engine.

The fuel injected to the combustion chamber 25 by the direct injection injector 39C is harder to mix well with air in the combustion chamber 25 compared with the fuel injected from the port injection injector 39P. Especially, when an idle operation is executed, the internal combustion engine 10 is in no load state, the amount of air in the combustion chamber 25 is small, and thus the fuel injected into the combustion chamber 25 by the direct injection injector 39C becomes more difficult to mix with air in the combustion chamber 25. Therefore, when the fuel is injected into the combustion chamber 25 only from the direct injection injector 39C during the idle operation, the combustion stability does not become good.

In addition, the direct injection injector 39C injects the high pressure fuel into the combustion chamber 25 which is at high air pressure. Therefore, the operating sound of the direct injection injector 39C is larger than that of the port injection injector 39P. In addition, when the internal combustion engine 10 executes the idle operation, the machine noise generated by the internal combustion engine 10 is smaller than that of when the internal combustion engine 10 executes the load operation. Thus, when the fuel is injected into the combustion chamber 25 only from the direct injection injector 39C during the idle operation of the internal combustion engine 10, the operating sound of the direct injection injector 39C may cause an occupant of the vehicle 1 to feel uncomfortable.

The intake system 40 comprises an intake pipe 41 including intake manifolds each of which is connected to the inlet port 31 of each cylinder, an air filter 42 located at the end of the intake pipe 41, a throttle valve 43 which is located in the intake pipe 41 and makes the intake opening area variable, and the actuator 43a for the throttle valve 43. The inlet port 31 and the intake pipe 41 are components of the intake passage.

The exhaust system 50 comprises exhaust manifolds 51 each of which is connected to the exhaust port 34 of each cylinder, an exhaust pipe 52 connected to the exhaust manifold 51, and a catalyst 53 (a three way catalyst) arranged in the exhaust pipe 52. The exhaust port 34, the exhaust manifold 51, and the exhaust pipe 52 are components of the exhaust passage.

The internal combustion engine 10 is provided with an air flowmeter 61, a throttle position sensor 62, a crank position sensor 64, and a water temperature sensor 65.

The air flowmeter 61 outputs a signal corresponding to mass flow rate (intake air flow rate) Ga of intake air flowing through the intake pipe 41.

The throttle position sensor 62 detects the opening degree TA of the throttle valve 43 and outputs a signal representing the throttle valve opening degree TA.

The crank position sensor 64 outputs a signal each time when the crank shaft 24 rotates by a predetermined angle. This signal is converted to the engine speed NE by an engine ECU 70 described later.

The water temperature sensor 65 detects a cooling water temperature THW which is temperature of cooling water of the internal combustion engine 10, and outputs a signal representing the cooling water temperature THW.

The igniter 38, the port injection injector 39P, the direct injection injector 39C, the actuator 43a, the air flowmeter 61, the throttle position sensor 62, the crank position sensor 64 and the water temperature sensor 65 are connected to the engine ECU 70.

Furthermore, an accelerator opening sensor 66 is connected to the engine ECU 70. The accelerator opening sensor 66 detects an operation amount AP of the accelerator pedal 67 operated by a driver and outputs a signal representing the operation amount AP.

Furthermore, a brake opening sensor 68 is connected to the engine ECU 70. The brake opening sensor 68 detects an operation amount BP of the brake pedal 69 operated by the driver, and outputs a signal representing the operation amount BP.

In this specification, “ECU” is an abbreviation of “Electronic Control Unit”. The ECU includes a microcomputer having “a CPU, a ROM, a RAM, a backup RAM, an interface, and etc.” which are mutually connected via a bus. Data, which includes a program executed by the CPU, a look-up table (a map), and constants, are stored in the ROM in advance. The RAM temporarily holds data according to the instruction from the CPU. The backup RAM holds data not only when an ignition key switch (or a ready switch for changing the vehicle 1 to the running enabled state) of the vehicle 1 is at the ON position but also when it is at the OFF position. The interface includes an AD converter.

Referring again to FIG. 1, each of the first electric motor 121 and the second electric motor 122 comprises a stator having a three-phase winding (coil) generating a rotating magnetic field and a rotor provided with a permanent magnet for generating a torque caused by the magnetic force between the rotor and the rotating magnetic field. That is, each of the first electric motor 121 and the second electric motor 122 is a synchronous generator motor that can function as a generator and/or as an electric motor.

The first electric motor 121 is mainly used as a generator. The first electric motor 121 cranks the internal combustion engine 10 at the start of the internal combustion engine 10. In addition, the first electric motor 121 generates a restraining torque having reverse direction with respect to the rotation direction of the internal combustion engine 10 in order to stop the rotation of the internal combustion engine 10 quickly when the internal combustion engine 10 is changed from the operating state (rotating state) to the stopped state.

The second electric motor 122 is mainly used as an electric motor and can generate a torque for making the vehicle 1 travel. That is, the second electric motor 122 functions as another one of drive sources of the vehicle 1.

The power dividing mechanism 131 is a planetary gear mechanism. More specifically, the power dividing mechanism 131 comprises a sun gear (not shown), a ring gear (not shown) concentrically arranged with this sun gear, a plurality of pinion gears (not shown) meshed with both the sun gear and the ring gear, and a pinion career (not shown) that holds the plurality of pinion gears so as to be rotatable and revolvable around the sun gear.

The output shaft of the first electric motor 121 is connected to the sun gear so that the torque can be transmitted. The crank shaft 24 of the internal combustion engine 10 is connected to the pinion career so that the torque can be transmitted. The ring gear is connected to the propeller shaft 133 via the speed reducing mechanism 132 so that the torque can be transmitted. An output shaft of the second electric motor 122 is connected to the ring gear via the speed reducing mechanism 132 so that the torque can be transmitted. Further, an output shaft of the second electric motor 122 is connected to the propeller shaft 133 via the speed reducing mechanism 132 so that the torque can be transmitted. The propeller shaft 133 is connected to a drive shaft 135F1 via a differential gear 134 so that the torque can be transmitted. Further, the left and right front wheels 135F are connected to both ends of the drive shaft 135F1 respectively via members (not shown) so that the torque of the drive shaft 135F1 is transmitted thereto.

The vehicle 1 comprises an accumulator battery 141, a boost converter 142 and an inverter 143. The accumulator battery 141 is a chargeable and dischargeable secondary battery (lithium ion battery in this embodiment). The DC power outputted by the accumulator battery 141 is voltage converted (boosted) by the boost converter 142. The voltage-converted DC power is converted to AC power by the inverter 143 and supplied to the first electric motor 121 and the second electric motor 122.

On the other hand, when the first electric motor 121 and/or the second electric motor 122 operate as a generator, the AC power generated by them is converted to DC power by the inverter 143. Further, the converted DC power is voltage converted (stepped down) by the boost converter 142 and supplied to the accumulator battery 141. As a result, the accumulator battery 141 is charged. The AC power generated by the first electric motor 121 is also supplied to the second electric motor 122 via the inverter 143.

The control unit 161 includes a plurality of ECUs for controlling the vehicle 1. That is, the control unit 161 includes an MG-ECU (not shown) which controls the first electric motor 121 and the second electric motor 122 by controlling the boost converter 142 and the inverter 143, a battery ECU (not shown) which acquires information on the remaining capacity (SOC: State of charge) of the accumulator battery 141 by a well-known method, and a power management ECU (PM-ECU) (not shown) in addition to the above-mentioned engine ECU 70. These ECUs are connected to each other so that information can be mutually transmitted and received via a CAN (Controller Area Network) (not shown). Some or all of these ECUs may be integrated into one ECU. In the following description, in order to simplify the explanation, the explanation will be made under the premise that these ECUs are integrated into one ECU and this one ECU serves as the control unit 161. Therefore, the control unit 161 can control the internal combustion engine 10 and can control the first electric motor 121 and the second electric motor 122.

The control unit 161 is configured to obtain the vehicle speed Vs (the rotation speed of the rear wheels 135R) of the vehicle 1 from a vehicle speed sensor 173 arranged in the vicinity of the right rear wheel 135R.

(Overview of Operation)

### <The Vehicle Control>

The control unit 161 controls the internal combustion engine 10 and the second electric motor 122, etc. as follows.

The control unit 161 is configured to calculate a torque (i.e., a driver request torque Tus) that is required for the ring gear of the power dividing mechanism 131 based on the operation amount AP of the accelerator pedal 67 obtained from the accelerator opening sensor 66 and the vehicle speed Vs obtained from the vehicle speed sensor 173. Further, the control unit 161 is configured to calculate a driver request output Pus based on the product of the driver request torque Tus and the vehicle speed Vs (that is, a value corresponding to the rotation speed of the ring gear) acquired by the vehicle speed sensor 173.

Further, the control unit 161 is configured to calculate a vehicle required output Pv by adding a predetermined vehicle loss Pv_loss to the driver request output Pus. When a battery charge/discharge request occurs, the control unit 161 calculates the vehicle required output Pv by adding the vehicle loss Pv_loss and the battery charge/discharge request Pchg to the driver request output Pus.

In addition, the control unit 161 quickly starts the internal combustion engine 10 when the vehicle required output Pv exceeds a predetermined engine startup threshold Pe-sta. At this time, the control unit 161 regards the vehicle required output Pv as an engine required output Pe and controls the internal combustion engine 10 based on this engine required output Pe.

After that, when the vehicle required output Pv becomes smaller than a predetermined engine stop threshold Pee_sto, the control unit 161 controls the internal combustion engine 10 while regarding the engine required output Pe as “0”. The control unit 161 quickly stops the internal combustion engine 10 when an engine stop request condition, which will be described later, is satisfied.

The control unit 161 controls the internal combustion engine 10 by controlling the igniter 38 (the ignition plug 37), the port injection injector 39P, the direct injection injector 39C and others.

At this time, the control unit 161 controls the injection amount of fuel from the port injection injector 39P and/or the direct injection injector 39C, ignition timing of the ignition plug 37, and etc. so that the internal combustion engine 10 outputs an output equal to the engine required output Pe. Further, the control unit 161 controls the torque of the second electric motor 122 to compensate for the difference between the torque generated in the ring gear by the operation of the internal combustion engine 10 and the driver request torque Tus, and thus controls the rotational speed and the torque of the first electric motor 121. The basic contents of such hybrid control are well known, and are disclosed in, for example, Japanese Patent Application Laid-Open No. 2009-126450 (U.S. Unexamined Patent Application Publication No. US 2010/0241297) and Japanese Patent Application Laid-Open No. 09-308012 (U.S. Pat. No. 6,131,680 which was filed on Mar. 10, 1997), and the like in detail in addition to Japanese Patent No. 5862296 and Japanese Patent No. 5682581.

On the other hand, when the engine stop request condition described later is satisfied, the control unit 161 executes fuel cut (stops fuel injection) and stops execution of ignition (stops operation to generate a spark for ignition) to thereby stops the operation of the internal combustion engine 10, and makes the second electric motor 122 operate to generate the torque that satisfies the driver request torque Tus. Furthermore, the control unit 161 restarts the operation of the internal combustion engine 10 when a predetermined engine restart condition to be described later is satisfied under the state where the operation of the internal combustion engine 10 is stopped as described above. Thus, the operation of the internal combustion engine 10 is intermittently stopped and restarted. That is, the internal combustion engine 10 is intermittently operated.

The engine stop request condition is satisfied when all the following conditions (1) (2) (3) (4) are satisfied.

(1) The engine required output Pe is less than or equal to 0 (an engine stop threshold Pe_sta).
(2) There is no vehicle cabin heating request of the vehicle 1. It should be noted that the control unit 161 receives a signal indicating whether or not the vehicle cabin heating request occurs from an air-conditioning ECU (not shown), and determines whether or not the vehicle cabin heating request occurs based on the signal.
(3) Battery remaining capacity (SOC) is greater than or equal to a threshold remaining capacity SOCth.
(4) The temperature Tc of the catalyst 53 is greater than or equal to a threshold activation temperature Tcth. The control unit 161 estimates the temperature Tc of the catalyst 53 based on the average value of the intake air amount Ga over a predetermined estimated time.

Therefore, the engine stop request condition is a condition that is satisfied when at least “the condition that the engine required output Pe is equal to or less than the predetermined engine stop threshold Pe_sta” is satisfied.

<The Injection Share Ratio>

By the way, the control unit 161 determines the amount of the fuel required for the internal combustion engine 10 (the total amount of fuel to be injected to the internal combustion engine 10, more precisely the total amount of fuel to be supplied in one combustion cycle of any one of cylinders) by a well-known method that uses the engine required output Pe, the engine speed NE and the cooling water temperature THW.

Furthermore, the control unit 161 is configured to determine a ratio of the amount of fuel injected from the direct injection injector 39C to the total amount of fuel (hereinafter it is referred to as “injection share ratio of the direct injection injector 39C” or “direct injection share ratio”). In addition, the control unit 161 is configured to determine a ratio of the amount of fuel injected from the port injection injector 39P to the total amount of fuel (hereinafter it is referred to as “injection share ratio of the port injection injector 39P” or “port injection share ratio”).

When the direct injection share ratio is A %, the port injection share ratio is (100−A) %. Therefore, in the present embodiment, the control unit 161 first determines the direct injection share ratio A % and calculates the port injection share ratio (100−A) % based on the direct injection share ratio A %. Of course, the control unit 161 may first determine the port injection share ratio B % and calculates the direct injection share ratio (100−B) % based on the port injection share ratio B %. Further, the control unit 161 may simultaneously calculate the direct injection share ratio A % and the port injection share ratio B %. Both the direct injection share ratio A % and the port injection share ratio B % are more than or equal to 0% and less than or equal to 100%.

More specifically, “an first injection share ratio map” and “an second injection share ratio map” both of which are used for determining the direct injection share ratio A % are recorded in the ROM of the engine ECU 70. Each of these injection share ratio maps is a two-dimensional map for obtaining the direct injection share ratio A % using the engine speed NE and the load of the internal combustion engine 10 (for example, the intake air flow rate Ga) as arguments. Each of these injection share ratio maps may be a three-dimensional map for obtaining the direct injection share ratio A % using the engine speed NE, the load of the engine and the cooling water temperature THW as arguments. Further, the load of the engine as an argument of these injection share ratio maps may be the operation amount AP of the accelerator pedal 67, the air filling rate, the engine required output Pe, or the like.

The direct injection share ratio A % determined by each of “the first injection share ratio map” and “the second injection share ratio map” becomes a value in the range from 0% to 100% inclusive depending on at least the load of the internal combustion engine 10. Therefore, the control unit 161 drives the direct injection injector 39C and the port injection injector 39P so that a state in which the amount of fuel required for the internal combustion engine is injected using both the direct injection injector 39C and the port injection injector 39P and another state in which the amount of fuel required for the internal combustion engine is injected using either the direct injection injector 39C or the port injection injector 39P is selectively occurred depending on at least the load of the internal combustion engine 10.

The control unit 161 determines the direct injection share ratio A % using the first injection share ratio map when the cooling water temperature THW detected by the water temperature sensor 65 is higher than a “temperature threshold Shhth”, and determines the direct injection share ratio A % using the second injection share ratio map when the cooling water temperature THW is less than or equal to “the temperature threshold Shhth”. The temperature threshold Shhth is, for example, a value in the range from 70° C. to 80° C. inclusive. That is, when the cooling water temperature THW is higher than the temperature threshold Shhth, the internal combustion engine 10 is considered to be in a normal temperature operation state (an operation state after low temperature operation, an operation state after warming-up operation), and thus the first injection share ratio map is selected. Meanwhile, when the cooling water temperature THW is less than or equal to the temperature threshold Shhth, the internal combustion engine 10 is considered to be in a low temperature operation state (an operation under low temperature state, a warming-up operation state), and thus the second injection share ratio map is selected.

<Operation of when the Operation of the Internal Combustion Engine is Stopped for the Intermittent Operation During a Low Temperature Operation>

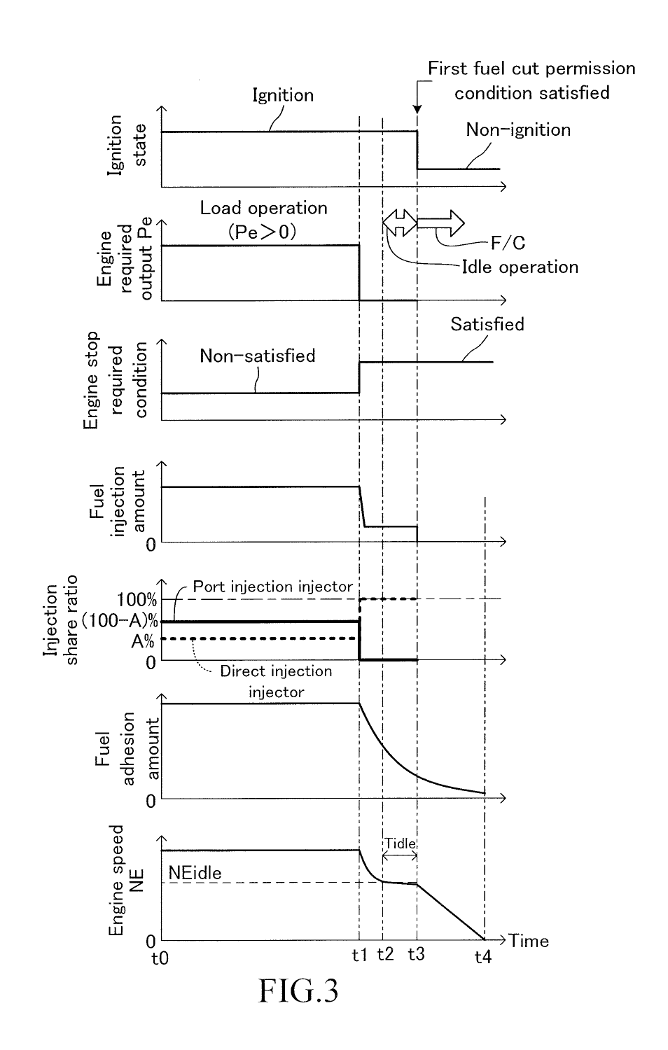

FIG. 3 is an example of a timing chart when the operation of the internal combustion engine 10 is stopped to execute the intermittent operation during the low temperature operation.

In the period of time from time t0 until just before time t1, the engine required output Pe is a positive value. That is, during this period of time the load of the internal combustion engine 10 is greater than the load when the idle operation is executed. This state is expressed as “the load operation of the internal combustion engine 10 is executed”. Since the internal combustion engine 10 is in the low temperature operation state now, the direct injection share ratio A % is determined based on the second injection share ratio map. When the load operation of the internal combustion engine 10 is executed, the direct injection share ratio A % determined by the second injection share ratio map is less than 100%. That is, the fuel is injected from the direct injection injector 39C and/or the port injection injector 39P. In addition, since the engine required output Pe has a certain magnitude (is larger than engine required output of when the idle operation is executed), the total amount of fuel (fuel injection amount) to be injected to the internal combustion engine 10 is also large. Furthermore, the magnitude of the negative pressure in the intake passage downstream of the throttle valve 43 is relatively small (the pressure in the intake passage is near the atmospheric pressure). Therefore, the fuel adhesion amount, which is the total amount of fuel adhered to the inner surface of the combustion chamber 25 and the inner surface of the inlet port 31, is large. The fuel adhesion amount shown in FIG. 3 is an estimated amount.

In this example, the engine required output Pe becomes “0” and the above engine stop request condition is satisfied at time t1. That is, the engine stop request condition changes from a non-satisfied state to a satisfied state at the time t1. At this time, the control unit 161 does not immediately start an operation for stopping the operation of the internal combustion engine 10 (that is, the control unit 161 does not stop the fuel cut operation and the ignition operation which will be described later) and continues the fuel injection and ignition operation to thereby change the operation state of the internal combustion engine 10 to the idle operation state. Further, the control unit 161 continues to make the internal combustion engine 10 in the idle operation state over a predetermined period of time (it is also referred to as “idle operation time period Tidle” for the sake of convenience). The control unit 161 sets the direct injection share ratio A % in this state to 100% as described in detail later. That is, in this state, all the fuel is injected from the direct injection injector 39C and no fuel is injected from the port injection injector 39P.

In the present embodiment, the “idle operation” is the operation state of the internal combustion engine 10 when the engine speed NE is equal to or less than a set idle upper limit rotational speed NEu, which is higher than a preset target idle rotation speed NEidle by a positive predetermined value a, the engine speed NE is equal to or higher than a set idle lower limit rotational speed Ned, which is lower than the target idle rotation speed NEidle by the predetermined value a, and the engine required output Pe is less than or equal to 0 (zero). That is, the idle operation time period Tidle is a period of time between the time, which comes after the time t1 and immediately before the time t2, and the time t3 in FIG. 3. The internal combustion engine 10 executes the idle operation during the idle operation time period Tidle.

If the time t3 comes when the idle operation time period Tidle elapses from (just before) the time t2, at which the internal combustion engine 10 becomes in the idle operation state, the control unit 161 stops the operation of the internal combustion engine 10 while starting the fuel cut operation (F/C), in which the fuel injection is stopped, and stopping the ignition operation. In other words, when the idle operation continues for the idle operation time period Tidle (from time t2 to time t3) at or after the time t1 at which the engine stop request condition is satisfied, a first fuel cut permission condition described in detail later is satisfied, and thus the fuel cut operation is executed. As a result, the engine speed NE of the internal combustion engine 10 falls sharply at or after time t3. At time t4, the engine speed NE becomes 0 (zero). That is, the operation (rotation) of the internal combustion engine 10 is completely stopped at time t4.

Although not shown in FIG. 3, when the engine required output Pe becomes equal to or greater than the engine startup threshold Pee_sta under a state where the operation of the internal combustion engine 10 is stopped at or after time t4, the control unit 161 determines that the engine restart condition is satisfied and then restarts the operation of the internal combustion engine 10. That is, the control unit 161 makes the ignition plug 37 generate a spark and makes at least one or both of the port injection injector 39P and the direct injection injector 39C inject the fuel having the starting fuel amount.

It should be noted that when the engine required output Pe becomes equal to or greater than the engine startup threshold Pee_sta in a state where the operation of the internal combustion engine 10 is not completely stopped at or after time t4, the control unit 161 determines that the engine restart condition is satisfied and then restarts the operation of the internal combustion engine 10.

It should be noted that “operation of the internal combustion engine for the intermittent operation when the internal combustion engine is stopped” of when the internal combustion engine 10 is in the normal temperature operation state is the same as the operation shown in the timing chart of FIG. 3 excluding the “direct injection share ratio A % and the fuel adhesion amount” in the time zone between time t1 and time t3. That is, in this case, the direct injection share ratio A % in the time zone between time t1 and time t3 is smaller than 100%, so that the fuel is injected from the port injection injector 39P and/or the direct injection injector 39C.

<HC Reduction at the Timing of Engine Restart in the Intermittent Operation>

By the way, when the operation of the internal combustion engine 10 is stopped and then the operation of the internal combustion engine 10 is restarted, the amount of hydrocarbon (HC) discharged to the outside (the atmosphere) from the internal combustion engine 10 through the exhaust pipe 52 is relatively large. In order to reduce the amount of HC, it is only necessary to reduce the concentration HC in the exhaust gas after the operation is restarted (after the operation of the internal combustion engine is restarted). This HC concentration becomes higher as “the total amount of fuel adhered to the inner surface of the combustion chamber 25 and the inner surface of the inlet port 31 (the fuel adhesion amount)” when the operation of the internal combustion engine 10 is stopped becomes larger. Therefore, in order to reduce the HC concentration after the operation is restarted, it is only necessary to reduce the fuel adhesion amount when the operation of the internal combustion engine 10 is stopped.

The inventors conducted intensive studies based on this viewpoint, and thus has found that if the idle operation is executed immediately before the operation of the internal combustion engine 10 is stopped with the injection share ratio (the direct injection share ratio A % and the port injection sharing (100−A) %) changing, the fuel adhesion amount can be reduced. In addition, the inventors considered that the fuel adhesion amount when the internal combustion engine 10 is in the low temperature operation state becomes larger than when the internal combustion engine 10 is in the normal temperature operation state.

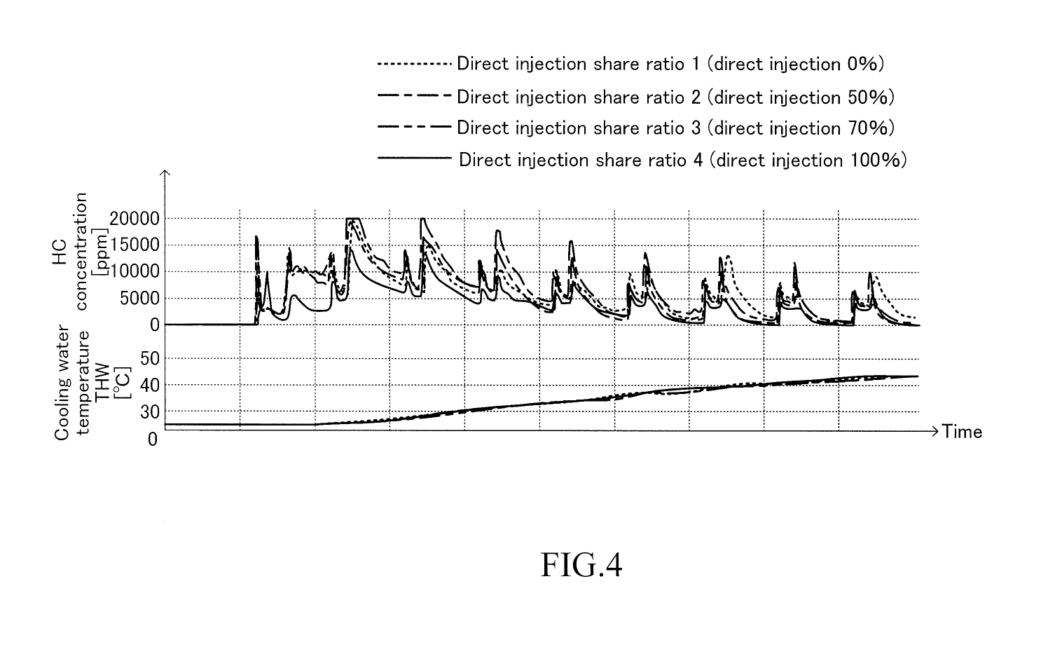

Thus, the inventors executed an experiment. In this experiment, the inventors made the internal combustion engine 10 in the low temperature operation state execute the idle operation while making the port injection injector 39P and the direct injection injector 39C inject the fuel based on the four different injection share ratios before stopping the operation of the internal combustion engine 10. Further, in this experiment, the inventors restarted the internal combustion engine 10 after stopping the operation of the internal combustion engine 10, and investigated the change of HC concentration (ppm) in the exhaust gas discharged to the outside when the internal combustion engine 10 is restarted. FIG. 4 shows the results of the experiment. Each injection share ratio is as follows.

The injection share ratio 1 (see the dashed line in FIG. 4):

The direct injection share ratio A %=0% and

The port injection share ratio (100−A) %=100%

The injection share ratio 2 (see the one-dot chain line in FIG. 4):

The direct injection share ratio A %=50% and

The port injection share ratio (100−A) %=50%

The injection share ratio 3 (see the two-dot chain line in FIG. 4):

The direct injection share ratio A %=70% and

The port injection share ratio (100−A) %=30%

The injection share ratio 4 (see the solid line in FIG. 4):

The direct injection share ratio A %=100% and

The port injection share ratio (100−A) %=0%

As shown in FIG. 4, it has come to light that in the case of the injection share ratio 4 (that is, the direct injection share ratio A %=100% and all the fuel is injected from the direct injection injector 39C), the HC concentration in the exhaust gas, when the operation of the internal combustion engine 10 was restarted, was the smallest. In other words, it has come to light that in the case of the injection share ratio 4, the fuel adhesion amount, when the operation of the internal combustion engine 10 was stopped after the internal combustion engine 10 executed the idle operation, was the smallest.

Therefore, as shown in FIG. 3, when the engine stop request condition is satisfied at time t1 under a state where the internal combustion engine 10 is in the low temperature operation state, the control unit 161 makes the direct injection injector 39C inject all of the fuel having the amount required to maintain the idle operation (i.e., the idle required fuel amount) while making the ignition device execute an ignition operation from time t1 until the time t3 at which a predetermined time elapses from time t1. As a result, as shown in FIG. 3, the fuel adhesion amount greatly decreases with the lapse of time in the time zone between time t1 and time t4 at which the internal combustion engine 10 is completely stopped, and it becomes very small at time t4. Therefore, when the internal combustion engine 10 restarts at a predetermined time which comes at or after time t4, the HC concentration in the exhaust gas discharged to the outside through the exhaust pipe 52 becomes a low value. As a result, the HC emission amount after the restart of the internal combustion engine 10 is greatly reduced as compared with the conventional device.

It should be noted that when stopping the operation of the internal combustion engine 10 in the normal temperature operation state for the intermittent operation, the control unit 161 also makes the internal combustion engine 10 execute the idle operation immediately before stopping the operation of the internal combustion engine 10. At this time, the control unit 161 may make the direct injection injector 39C inject all the fuel similarly to the case where the internal combustion engine 10 is in the low temperature operation state.

However, as is well known, when the internal combustion engine 10 is in the normal temperature operation state, the fuel adhesion amount is smaller compared with the case where the internal combustion engine 10 is in the low temperature operation state. Therefore, even when the fuel is injected from both the direct injection injector 39C and the port injection injector 39P under a state where the internal combustion engine 10 executes the idle operation before being stopped, the HC concentration in the exhaust gas when the operation of the internal combustion engine 10 is restarted becomes a relative low value.

On the other hand, since the direct injection injector 39C has to inject high pressure fuel into the combustion chamber 25 having high pressure, the operating sound (mechanical noise) of the direct injection injector 39C is larger than that of the port injection injector 39P, and the operating sound increases as the amount of fuel injected from the direct injection injector 39C increases. In addition, when the internal combustion engine 10 executes the idle operation, the operating sounds generated by the piston 22, the connecting rod 23 and the crank shaft 24, etc. are smaller than when the internal combustion engine 10 executes the load operation. Thus, when the internal combustion engine 10 executes the idle operation, the operating sound of the direct injection injector 39C may cause an occupant of the vehicle to feel uncomfortable.

Thus, when the internal combustion engine 10, which is in the normal temperature operation state, stops its operation for the intermittent operation, the control unit 161 makes the internal combustion engine 10 execute the idle operation immediately before stopping the operation of the internal combustion engine 10. However, during this idle operation, the control unit 161 makes the direct injection injector 39C and/or the port injection injector 39P inject the fuel. As a result, it is possible to reduce the possibility of the occupant of the vehicle 1 feeling uncomfortable due to the operating sound of the direct injection injector 39C with the emission amount of HC kept low after the restart of the internal combustion engine 10.

<Specific Operation>

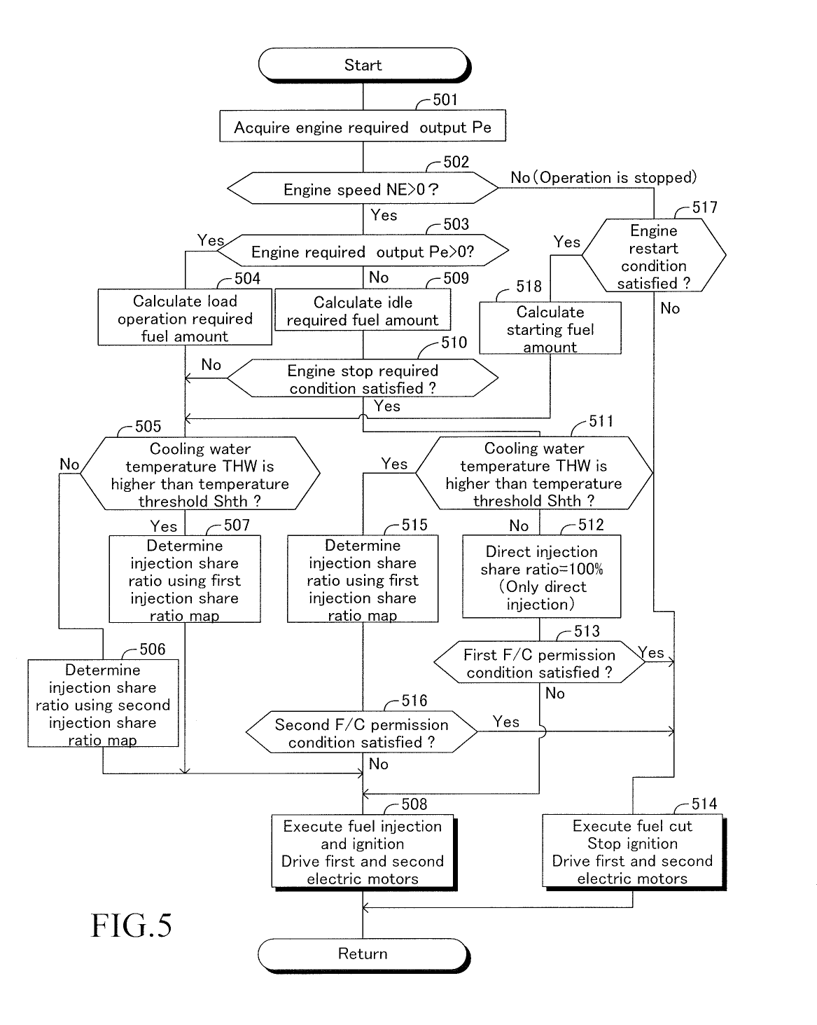

Next, specific control of the internal combustion engine 10 by the control unit 161 will be described with reference to the flowchart of FIG. 5. When the ignition switch (or the ready switch) is switched from the OFF position to the ON position, the control unit 161 starts the operation of the internal combustion engine 10 based on a starting routine (not shown). At this time, the control unit 161 determines the injection share ratio (A %) of the direct injection injector 39C and the injection share ratio (100−A) % of the port injection injector 39P depending on the cooling water temperature THW, and makes the direct injection injector 39C and/or the port injection injector 39P inject the fuel depending on the injection share ratio thereof.

Thereafter, as long as the ignition switch (or ready switch) is set to the ON position, the control unit 161 repeatedly executes the routine shown by the flowchart of FIG. 5 each time a predetermined interval elapses.

First, in step 501, the control unit 161 calculates the driver request output Pus based on the product of the driver request torque Tus and the vehicle speed Vs acquired by the vehicle speed sensor 173. The control unit 161 further calculates the vehicle required output Pv by adding the vehicle loss Pv_loss to the driver request output Pus. When the battery charge/discharge request occurs, the control unit 161 calculates the vehicle required output Pv by adding the vehicle loss Pv_loss and the battery charge/discharge request Pchg to the driver request output Pus.

In addition, the control unit 161 considers the vehicle required output Pv as the engine required output Pe and obtains the engine required output Pe when the internal combustion engine 10 is in the operation state and the vehicle required output Pv is greater than or equal to the engine stop threshold Pe_sto. On the other hand, when this condition is not satisfied, the control unit 161 considers the engine required output Pe as “0” and obtains the engine required output Pe.

Subsequently, the control unit 161 proceeds to step 502 to determine whether or not the engine speed NE acquired from the crank position sensor 64 is greater than 0 (zero). In other words, the control unit 161 determines whether or not the internal combustion engine 10 is operating (rotating) (i.e., whether or not the internal combustion engine 10 is stopped).

When the internal combustion engine 10 is in the operation state (i.e., when the engine speed NE is greater than 0), the control unit 161 determines “Yes” in step 502, and proceeds to step 503 to determine whether or not the engine required output Pe, which was acquired in step 501, is larger than “0 being the engine stop threshold (threshold output)”.

Now, the engine required output Pe is assumed to be greater than 0. In this case, the control unit 161 determines “Yes” in step 503 and thus proceed to Step 504 to calculate “load operation required fuel amount” on the basis of the engine required output Pe, the engine speed NE, and the cooling water temperature THW. Next, the control unit 161 proceeds to step 505 to determine whether or not the cooling water temperature THW obtained from the water temperature sensor 65 is higher than the temperature threshold Shhth.

When the internal combustion engine 10 is in the low temperature operation state, the cooling water temperature THW is less than or equal to the temperature threshold Shhth. In this case, the control unit 161 determines No in step 505 and thus proceeds to step 506 to determine the injection share ratio (A %) of the direct injection injector 39C and the injection share ratio (100−A) % of the port injection injector 39P according to the second injection share ratio map. Thereafter, the control unit 161 proceeds to step 508.

In contrast, when the internal combustion engine 10 is in the normal temperature operation state, the cooling water temperature THW is higher than the temperature threshold Shhth. In this case, the control unit 161 determines Yes in step 505 and thus proceeds to step 507 to determine the injection share ratio (A %) of the direct injection injector 39C and the injection share ratio (100−A) % of the port injection injector 39P according to the first injection share ratio map. Thereafter, the control unit 161 proceeds to step 508.

When proceeding to step 508, the control unit 161 sets the direct injection injector 39C to inject fuel having an amount corresponding to A % of the load operation required fuel amount calculated in step 504 at a predetermined fuel injection timing thereof, and sets the port injection injector 39P to inject fuel having an amount corresponding to (100−A) % of the load operation required fuel amount at a predetermined fuel injection timing thereof. Furthermore, the control unit 161 makes the ignition plug 37 generate a spark at a predetermined ignition timing thereof. As a result, the control unit 161 makes the internal combustion engine 10 execute the load operation. In addition, the control unit 161 drives the first electric motor 121 and the second electric motor 122 as described above and gives the ring gear the torque equal to the driver request torque Tus. Upon completion of the process of step 508, the control unit 161 temporarily ends this routine.

On the other hand, when the engine required output Pe is less than or equal to 0 at the time at which the control unit 161 executes the process of step 503, the control unit 161 determines No in step 503 and thus proceeds to step 509 to calculate the fuel amount necessary for making the internal combustion engine 10 execute the idle operation (i.e., the idle required fuel amount) based on the cooling water temperature THW. Thereafter, the control unit 161 proceeds to step 510 to determine whether or not the above engine stop request condition is satisfied.

When the engine stop request condition is not satisfied, the control unit 161 determines No in step 510, and proceeds to step 505 and subsequent steps. As a result, the control unit 161 makes the internal combustion engine 10 execute the idle operation (that is, the internal combustion engine 10 executes autonomous operation, and the output of the internal combustion engine 10 becomes 0). In this case, the injection share ratio (A %) of the direct injection injector 39C determined in steps 506 and 507 is smaller than 100%. In other words, in the idle operation when the engine stop request condition is not satisfied, the port injection injector 39P also injects the fuel in order that the operating sound of the direct injection injector 39C does not cause the occupant of the vehicle 1 to feel uncomfortable.

On the other hand, when the engine stop request condition is satisfied at the time at which the control unit 161 executes the process of step 510, the control unit 161 determines Yes in step 510 and thus proceeds to step 511 to determine whether or not the cooling water temperature THW obtained from the water temperature sensor 65 is higher than the temperature threshold Shhth.

When the internal combustion engine 10 is in the low temperature operation state, the cooling water temperature THW is less than or equal to the temperature threshold Shhth. In this case, the control unit 161 determines No in step 511 and thus proceeds to step 512 to set the injection share ratio (A %) of the direct injection injector 39C to 100% and set the injection share set ratio (100−A) % of the port injection injector 39P to 0%. That is, in this case, when the process of step 508 is executed later, the fuel having the idle required fuel amount calculated in step 509 is injected only from the direct injection injector 39C and no fuel is injected from the port injection injector 39P.

Thereafter, the control unit 161 proceeds to step 513 to determine whether or not the first fuel cut permission condition (the first F/C permission condition) is satisfied. The first F/C permission condition is satisfied when the idle operation state, which is a state where the engine speed NE is equal to or less than the set idle upper limit rotational speed NEu and is equal to or larger than the set idle lower limit rotational speed Ned, continues for a first predetermined period of time (the time corresponding to the idle operation time period Tidle) from the predetermined time (the time immediately before the time t2) (i.e., a second time) coming at or after the time (i.e., a first time) at which the determination in step 510 is changed from a negative determination to a positive determination. In other words, the first F/C permission condition is satisfied when a third time comes. The third time is the time which comes at or after the first time, at which the engine stop request condition is changed from the non-satisfied state to the satisfied state, and is the time which comes when the idle operation state continues for equal to or more than the first predetermined period of time from the second time, at which the operation state of the internal combustion engine 10 becomes in the idle operation state.

When the first F/C permission condition is not satisfied, the control unit 161 determines No in step 513, and proceeds to step 508. As a result, the control unit 161 makes the direct injection injector 39C inject all of the fuel having the amount which is required for making the engine speed NE equal to be the idle rotational speed (i.e., the idle required fuel amount calculated in step 509) while making the port injection injector 39P inject no fuel. Upon completion of the process of step 508, the control unit 161 temporarily ends this routine. As a result, after that, the fuel adhesion amount decreases sharply.

On the other hand, when the first F/C permission condition is satisfied at the time at which the control unit 161 executes the process of step 513, the control unit 161 determines Yes in step 513 and proceeds to step 514.

In step 514, the control unit 161 makes the direct injection injector 39C stop injecting the fuel and maintains the stop state of fuel injection from the port injection injector 39P. That is, the control unit 161 executes a fuel cut operation. At this time, the control unit 161 does not make the ignition plug 37 generate a spark. That is, the control unit 161 stops the ignition operation. In addition, the control unit 161 drives the second electric motor 122 so that a torque equal to the driver request torque Tus is given to the ring gear. After finishing the process of step 514, the control unit 161 temporarily ends this routine. As a result, the engine speed NE sharply decreases after that and the internal combustion engine 10 eventually stops.

On the other hand, when the internal combustion engine 10 is in the normal temperature operation state at the time at which the control unit 161 executes the process of step 511, the cooling water temperature THW is higher than the temperature threshold Shhth. In this case, the control unit 161 determines Yes in step 511, and proceeds to step 515 to determine the injection share ratio (A %) of the direct injection injector 39C and the injection share ratio (100−A) % of the port injection injector 39P in accordance with the first injection share ratio map, which is also used in the above-described step 507.

When the engine required output Pe is less than or equal to 0, the first injection share ratio map sets the injection share ratio (A %) of the direct injection injector 39C to a value less than 100%. Therefore, in this case, when the process of step 508 is executed later, the fuel is injected not only from the direct injection injector 39C but also from the port injection injector 39P. Since this reduces the amount of fuel injected from the direct injection injector 39C, the possibility of the operating sound of the direct injection injector 39C causing the occupant of the vehicle 1 to feel uncomfortable is reduced, especially during the idle operation. Furthermore, since the internal combustion engine 10 is in the normal temperature operation state, even if the fuel is also injected from the port injection injector 39P, the fuel adhesion amount does not become excessive. As a result, thereafter, when the operation of the internal combustion engine 10 is restarted after it is stopped, the emission amount of HC does not become large.

Thereafter, the control unit 161 proceeds to step 516 to determine whether or not a second fuel cut permission condition (a second F/C permission condition) is satisfied. The second F/C permission condition is satisfied when the idle operation state, which is a state where the engine speed NE is equal to or less than the set idle upper limit rotational speed NEu and is equal to or larger than the set idle lower limit rotational speed Ned, continues for a second predetermined period of time at or after the time at which the determination in step 510 is changed from a negative determination to a positive determination. In other words, the second F/C permission condition is satisfied when a third time comes. The third time is the time which comes at or after the first time, at which the engine stop request condition is changed from the non-satisfied state to the satisfied state, and is the time which comes when the idle operation state continues for equal to or more than a second predetermined period of time from the second time, at which the operation state of the internal combustion engine 10 becomes in the idle operation state. It should be noted that the second predetermined period of time may be different from the first predetermined period of time described above or may be the same as the first predetermined period of time.

When the second F/C permission condition is not satisfied, the control unit 161 determines No in step 516, and proceeds to step 508. As a result, the control unit 161 makes both the direct injection injector 39C and the port injection injector 39P inject the fuel having the amount which is required for making the engine speed NE equal to be the idle rotational speed (i.e., the idle required fuel amount). Upon completion of the process of step 508, the control unit 161 temporarily ends this routine.

On the other hand, when the second F/C permission condition is satisfied at the time at which the control unit 161 executes the process of step 516, the control unit 161 determines Yes in step 516 and proceeds to step 514. Thus, the fuel cut operation is executed by the process of step 514, and the spark for ignition from the ignition plug 37 is not generated. Upon completion of the process of step 514, the control unit 161 temporarily ends this routine.

By this process in step 514, the rotational speed of the internal combustion engine 10 decreases and eventually becomes zero. That is, the internal combustion engine 10 becomes in the stopped state. Thereafter, when the control unit 161 proceeds to step 502, the control unit 161 determines No in the step 502 and proceeds to step 517.

The control unit 161 determines whether or not the engine restart condition is satisfied by determining whether or not the engine required output Pe is equal to or larger than the engine startup threshold Pee_sta (value equal to or larger than 0) in step 517. When the engine restart condition is not satisfied, the control unit 161 determines No in step 517 and proceeds to step 514. As a result, the internal combustion engine 10 is maintained in the stopped state.

On the other hand, when the engine restart condition is satisfied, the control unit 161 determines Yes in step 517, and proceeds to step 518 to determine the fuel amount necessary for starting the internal combustion engine 10 (the starting fuel amount) based on the cooling water temperature THW. Thereafter, the control unit 161 proceeds to step 505 and subsequent steps. As a result, since fuel injection to the internal combustion engine 10 and ignition are restarted, the internal combustion engine 10 is restarted. In this case, since the fuel adhesion amount is small, the HC concentration of the exhaust gas emitted to the atmosphere is low.

As described above, the control device for internal combustion engine according to the embodiment of the present invention can reduce the concentration of HC contained in the exhaust gas when the internal combustion engine 10 is restarted.

This control device executes the idle operation while making only the direct injection injector 39C inject the fuel when the internal combustion engine 10 is in the low temperature operation state. In this case, the occupant of the vehicle 1 may feel uncomfortable with the operating sound of the direct injection injector 39C. However, since the period of time for the idle operation to be executed just before the control device stops the operation of the internal combustion engine 10 can be set to a short time (i.e., the first predetermined period of time can be set to a short time), the operating sound of the direct injection injector 39C causes practically no problem.

Since the fuel is injected only from the direct injection injector 39C during the idle operation executed just before the operation of the internal combustion engine 10 is stopped, the combustion may be slightly unstable. However, during the idle operation, the output of the internal combustion engine 10 is not used as a driving force to make the vehicle 1 travel. Therefore, in this case, instability of combustion practically causes no problem.

Although the present invention has been described based on the above embodiments, the present invention is not limited to the above embodiments, and various modifications are possible without departing from the object of the present invention.

For example, if the vehicle on which the internal combustion engine 10 is mounted is a vehicle that executes start-and-stop control (hereinafter referred to as “S & S control”) for the internal combustion engine 10, the present invention may be applied to this internal combustion engine 10.

As is well known, in the S & S control, the operation is stopped when the predetermined engine stop request condition is satisfied, and the operation is restarted when the predetermined engine restart condition is satisfied. That is, in the S & S control, when the intermittent operation of the internal combustion engine is executed and the engine stop request condition is satisfied, the present invention can be applied. It should be noted that, in the S & S control, the engine stop request condition is satisfied when, for example, the brake device is in a operation state and the vehicle speed becomes equal to or less than the predetermined speed (for example, zero). Further, when the vehicle is an automatic vehicle, which has an automatic transmission and executes the S & S control, the engine restart condition is satisfied when, for example, a shift lever for operating the automatic transmission is positioned in a traveling range (for example, a drive (D) range) and an operation amount BP of a brake pedal thereof becomes smaller than a predetermined amount. Meanwhile, when the vehicle is a manual mission vehicle, which has a manual transmission and executes the S & S control, the engine restart condition is satisfied when, for example, a clutch pedal thereof is depressed.

In the above embodiment, the control unit 161 sets the injection share ratio of the direct injection injector 39C to 100% at time t1 in FIG. 3, and maintains this state until time t3.

However, the control unit 161 may set the injection share ratio of the direct injection injector 39C to 100% at the time which comes after time t1 and before time t3 (for example, a predetermined time, which comes after time t1 and at which the engine speed NE is changed from a value higher than the set idle upper limit rotational speed NEu to a value lower than the set idle upper limit rotational speed NEu, or another time which comes after this predetermined time).

Furthermore, the amount of fuel supplied to the internal combustion engine 10 between time t1 and time t2 in FIG. 3 may be less than the idle required fuel amount.

What is claimed is:

1. A control device for an internal combustion engine applied to said internal combustion engine, said internal combustion engine comprising:
a direct injection injector capable of injecting fuel into a combustion chamber formed between an inner surface of a cylinder and a piston reciprocating in said cylinder; and
a port injection injector capable of injecting said fuel into an intake port connected to said cylinder,
wherein,
said control device comprises a control unit for driving said direct injection injector and said port injection injector so that a state in which said fuel having an amount required for said internal combustion engine is injected from both said direct injection injector and said port injection injector and a state in which said fuel having an amount required for said internal combustion engine is injected from either said direct injection injector or said port injection injector selectively occurs depending on at least load of said internal combustion engine,
said control unit is configured to:
make said direct injection injector inject all of said fuel having an idle required fuel amount required for an idle operation and make said port injection injector inject no fuel from a second time to a third time so that said internal combustion engine executes said idle operation from said second time to said third time, said second time coming at or after a first time at which a predetermined engine stop request condition is determined to be satisfied, said third time coming when a predetermined period of time elapses from said second time;
execute a fuel cut operation in which said fuel is not injected from both said direct injection injector and said port injection injector from said third time so that operation of said internal combustion engine is stopped at or after said third time; and
make at least one of said direct injection injector and said port injection injector inject said fuel so that said operation of said internal combustion engine is restarted when a predetermined engine restart condition is satisfied under a state where said operation of said internal combustion engine is stopped at or after said third time.

2. The control device for internal combustion engine according to claim 1, wherein,
said control unit is configured to:
make only said direct injection injector inject said fuel having said idle required fuel amount from said first time to said third time when temperature of said internal combustion engine is equal to or less than a predetermined temperature threshold; and
make said port injection injector inject some or all of the fuel having said idle required fuel amount and make said direct injection injector inject remaining part of the fuel having said idle required fuel amount from said first time to said third time when said temperature of said internal combustion engine is higher than said temperature threshold.

3. The control device for internal combustion engine according to claim 2, wherein,
said internal combustion engine is mounted on a hybrid vehicle including an electric motor as a driving source, said internal combustion engine serving as one of other driving sources of said hybrid vehicle,
said control unit is configured to:
calculate an engine required output required for said internal combustion engine based on a torque requested by a driver of said hybrid vehicle to make said hybrid vehicle travel; and
determine that said engine stop request condition is satisfied when a condition that said engine required output is equal to or less than a predetermined engine stop threshold is at least satisfied.
